(19) United States
(12) Patent Application Publication
(10) Pub. No.: US 2010/0045434 A1
(43) Pub. Date: Feb. 25, 2010

(54) COMMUNICATION BETWEEN A COMMUNICATION STATION AND DATA CARRIERS

(75) Inventor: Franz Amtmann, Graz (AT)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 11/815,208

(22) PCT Filed: Jan. 24, 2006
(86) PCT No.: PCT/IB2006/050256

§ 371 Date: Jul. 31, 2007

(30) Foreign Application Priority Data
Jan. 31, 2005 (EP) 05100614.6

(51) Int. Cl. H04Q 5/22

(52) U.S. Cl. 340/10.1

(57) ABSTRACT

The invention relates to a method of communication between a communication station (1) and data carriers (2), and furthermore to such a communication station (1) and to such data carriers (2). According to the invention the communication station (1) is adapted to receive and identify response signals (RDB) of different lengths (L) supplied by the data carriers (2). Said length (L) of the response signals (RDB) provided by the data carriers (2), which data carriers (2) are adapted to generate response signals (2) with different lengths (L), is determined in or before an interrogation cycle (IPER) before the response signals (RDB) with said length (L) are supplied by the data carriers (2) in response to the interrogation signal (IDB). In a specific solution the length (L) is determined in each interrogation cycle.

### FIELD OF THE INVENTION

The invention relates to a method of communication between a communication station and data carriers.

The invention further relates to a communication station for the communication with data carriers.

The invention also relates to a data carrier for the communication with a communication station.

### BACKGROUND OF THE INVENTION

During communication between a communication station and a plurality of such data carriers, which for example are well-known RFID-tags (“Radio Frequency Identification”), the communication station, for example a reading/writing unit for such RFID-tags, first of all supplies an interrogation signal to some of or all the data carriers present within a communication range of the communication station in the course of an interrogation cycle, after which the responsive data carriers each supply a response signal to the communication station. Such a method of communication between a communication station and data carriers is well-known and described in more detail for example in the document WO 2002/011 054.

For the response signals generated with the aid of the data carriers a so-called collision occurs between some of these response signals, namely in the case that at least parts of at least two response signals appear in such a manner that they cannot be distinguished from one another, as a result of which the communication station is not capable of unambiguously identifying those data carriers from which the at least partly indistinguishable response signals originate.

Subsequently, either no acknowledge signal or a negative acknowledge signal is supplied to such data carriers from the communication station.

However, of the response signals generated with the aid of the data carriers some of these response signals also appear separately, i.e. each of these response signals can be distinguished unambiguously from the other in such a manner that each of these response signals can be identified unambiguously with the aid of the communication station, after which the communication station supplies for each unambiguously identified response signal an acknowledge signal to the data carrier which has supplied this unambiguously identified response signal, as a result of which information is received and is subsequently available in the data carrier that the relevant data carrier has been identified unambiguously by the communication station.

In the case of the known method, the known communication station and the known data carrier the communication station first generates an interrogation signal during an interrogation cycle and transfers this to some or to all the data carriers present in the communication range of the communication station. The communication station is then set to transmitting and the data carriers to receiving. Subsequently, the communication station is switched from transmitting to receiving and the data carriers are switched from receiving to transmitting, after which the data carriers responding to the previously received interrogation signal transmit their response signals to the communication station. The transmission of the response signals from the data carriers to the communication station is then usually effected in so-called time slots, a given number of time slots being selected and each data carrier being assigned to a time slot on the basis of, for example, the serial number of each data carrier.

Within such a time slot one or more data carriers first of all each transfer a response signal to the communication station. In this time slot the communication is subsequently switched from receiving to transmitting and at the same time the data carrier or data carriers are switched from transmitting to receiving. Subsequently, the communication station transmits the acknowledge signal, which is a positive acknowledge signal when only one data carrier has transmitted a response signal to the communication station in the relevant time slot, or which is a negative acknowledge signal when more than one data carrier has transmitted a response signal to the communication station in the relevant time slot. After the transmission of the acknowledge signal another switching operation is effected, i.e. the communication station is now switched from transmitting to receiving and the data carrier or the data carriers are switched from receiving to transmitting.

According to the state of art the data carriers answer with response signals with a fixed length. The term “fixed length” means that all responsive data carriers present in the communication range of the communication station always answer with a response signal with an equal length, and wherein the length of the response signals is constant in the subsequent interrogation cycles, thus the length of the response signals being fixed to a certain length for all interrogation cycles.

With the known solutions, unfortunately, it has emerged that in the case of a short fixed length of the response signals the probability of collisions is rather high, which means that two or more data carriers may answer with identical response signals or that a data carrier with a weak response signal may not be detected by the communication station since the response signal is masked by another data carrier which is closer to the communication station an answers with a stronger response signal.

If a long fixed length is used for the response signals the probability of collisions is reduced. However, using a long fixed length provides the disadvantage that the identification of the data carriers lasts longer, thus reducing the rate of identification of data carriers.

### OBJECT AND SUMMARY OF THE INVENTION

It is an object of the invention to provide a method of the type mentioned in the first paragraph and a communication station of the type mentioned in the second paragraph and a data carrier of the type mentioned in the third paragraph, which obviate the drawbacks described above.

To achieve the object described above, characteristic features according to the invention are provided with a method according to the invention, so that a method according to the invention can be characterized as follows:

A method of communication between a communication station and data carriers, which data carriers are present within a communication range of the communication station, in which for starting an interrogation cycle the communication station supplies an interrogation signal to data carriers present within the communication range, and in which during an interrogation cycle at least some of the data carriers present within the communication range which receive the interrogation signal each supply a response signal in response to the interrogation signal, wherein the response signals supplied by the data carriers and received by the communication station have a length, and wherein said length of said response signals is determined in or before an interrogation cycle before the response signals with said length are supplied by the data carriers in response to the interrogation signal.

To achieve the object defined above, characteristic features according to the invention are provided with a communication station according to the invention, so that a communication station according to the invention can be characterized as follows:

A communication station for the communication with data carriers, which data carriers are present within a communication range of the communication station, in which communication station interrogation signal generating means have been provided, with the aid of which an interrogation signal can be generated for starting an interrogation cycle, and in which transfer means have been provided, with the aid of which the generated interrogation signal can be supplied to data carriers present within the communication range, so that the interrogation signal can be received by the data carriers present within the communication range, and in which station receiving means have been provided, with the aid of which response signals supplied by the data carriers in response to a received interrogation signal can be received, and wherein response signal identification means are provided, with the aid of which response signals with different lengths can be identified.

To achieve the object defined above, characteristic features according to the invention are provided with a data carrier according to the invention, so that a data carrier according to the invention can be characterized as follows:

A data carrier for the communication with a communication station, which communication station has a communication range, in which communication range such data carriers are present, and in which data carrier data carrier receiving means have been provided, with the aid of which an interrogation signal supplied by the communication station can be received, and in which response signal generating means have been provided, with the aid of which a response signal can be generated in response to the received interrogation signal, and in which data carrier transfer means have been provided, with the aid of which the generated response signal can be supplied to the communication station, and in which the response signal generating means are adapted to generate response signals of different length.

The provision of the characteristic features according to the invention creates the advantage that is possible to adjust the length of the response signals under consideration of the specific circumstances or to use data carriers, which are transmitting response signals with different length. For example, the length of the response signals can be adjusted to the number of data carriers, which are arranged or are expected to be arranged in the communication range of the communication station. With this adjustment of the length of the response signals a fast identification of data carriers can be achieved, and at the same time it is possible to minimize the probability of the occurrence of collisions.

The length of the response signals can be determined by the communication station or the data carriers for a certain given interrogation cycle, and this length may then be valid for a particular number of interrogation cycles, for example for a complete interrogation process consisting of a particular number of interrogation cycles. In this case, the length is determined in or before a given interrogation cycle, preferably in or before the first interrogation cycle, and is then held constant for the following interrogation cycles of said interrogation process. For the next interrogation process, a new length is determined accordingly.

However, it has proved to be particularly advantageous if the length of the response signal is determined in or before each interrogation cycle. This yields the advantage that the length of the response signals may be changed very fast, which is for example of advantage when the number of data carriers in the communication range of communication station varies rapidly.

Some solutions according to the invention, in which the lengths of the response signals of the data carriers are random numbers, which random numbers are determined in or before a given interrogation cycle, offer the advantage that the average length of the response signals is approximately only half a given maximum length, which provides a faster communication than in the case that all data carriers answering supply a response signal with the given maximum length.

Furthermore, the interference resistance is improved since the communication further can use the different lengths of the response signals to identify said response signals.

The identification rate, that is the number of data carriers being identified by the communication station in a given time interval, depends on the length of the response signals. Long response signals are reducing the rate of identification. In this context it has proved to be particularly advantageous if a maximum value for the random numbers is defined before the response signals with lengths according to the random numbers are supplied by the data carriers. This yields the advantage that the identification rate may be influenced and enhanced by providing an upper limit for the random number length of the response signals.

Additionally, it may also be provided that a minimum length is defined for the length of the response signals to keep the probability for the occurrence of collisions low.

The length may be determined by the communication station or the data carrier, as already mentioned above. However, especially in the case of a lengths corresponding to random numbers it is of advantage when the random number for the length of a response signal of a particular data carrier is determined by said data carrier, as usually a data carrier comprises a random number generator, which then can be used for generating the random number for the length of the response signal. Furthermore, especially in this embodiment the already mentioned advantages concerning the average length of the response signals and the improved interference resistance are provided reliably.

In a solution according to the invention it is provided that the length of the response signals or the maximum value of the random numbers is defined by the communication station, and wherein length information describing said length of the response signals or said maximum value of the random numbers is transmitted by the communication station to the data carriers, and wherein the data carriers generate response signals according to said length information, which response signals are then supplied to the communication station. The communication station can receive instructions of how to define or determine the length information from a host computer or the communication station is adapted to determine itself which length information has to be provided to the data carriers. For example, the communication station may comprise means for detecting the number of data carriers in the communication range. With the above solution it is then possible to immediately adapt the length of the response signals of the data carriers accordingly.

In this context attention should be drawn to the term “in or before an interrogation cycle” as used in the claims. If we assume that per definition an interrogation cycle is started with the transmission of an interrogation signal from the communication station to the data carriers then the length of response signals is determined “before” the interrogation cycle when the communication station defines the concrete length of the response signals with the aid of length defining means.

In the case that the communication station only transmits, for example, the maximum value for the length, but the length itself is determined by the data carriers, for example with the aid of a random number generator, then the length is determined “in” the interrogation cycle.

Furthermore, it is also possible that for example the number of data carriers is determined during an interrogation cycle, which interrogation cycle consists of a number of time slots. If there are, for example, no response signals in two or more consecutive time slots, it may be assumed that there is only a small number of data carriers being present in the communication range of the communication station, whereas in the case that collisions in two or more consecutive time slots occur the number of data carriers being present in the communication range may be assumed to be large. The interrogation cycle may then be stopped by the communication station and a new interrogation cycle with a new length may be started.

In a solution according to the invention, there may be provided that the length information may be transmitted to the data carriers with a specific length information signal by the communication station. However, it has proved to be particularly advantageous if said length information is transmitted from the communication station to the data carriers as part of the interrogation signal. This yields the advantage that it is not necessary that the well-known course of an interrogation cycle is changed, since due to the inclusion of the length information into the interrogation signal no further length information signal has to be generated and transmitted to the data carriers.

These and other aspects of the invention are apparent from and will be elucidated with reference to the embodiments described hereinafter.

### BRIEF DESCRIPTION OF THE DRAWINGS

The invention will be described in greater detail hereinafter, by way of non-limiting example, with reference to the embodiments shown in the drawings.

FIG. 1 is a block diagram, which diagrammatically shows a communication station in accordance with the invention for the communication with data carriers.

FIG. 2 shows, in a manner similar to FIG. 1, a data carrier for the communication with the communication station shown in FIG. 1.

FIG. 3 shows schematically an interrogation cycle between a communication station and a data carrier as known from the state of the art.

FIG. 4 shows schematically the first two signals in an interrogation cycle according to a first embodiment of the invention.

FIG. 5 shows schematically the first two signals in an interrogation cycle according to a second embodiment of the invention.

### DESCRIPTION OF EMBODIMENTS

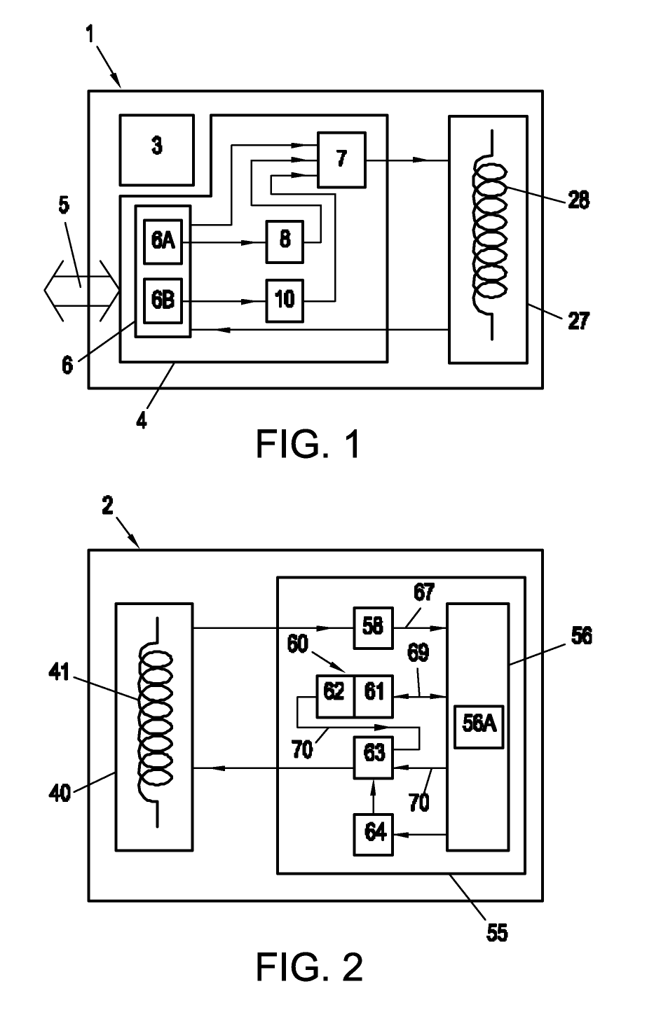

FIG. 1 shows a communication station 1 for the communication with data carriers 2, of which a data carrier 2 is shown in FIG. 2. Communication between the communication station 1 and the data carriers 2 is possible when the data carriers 2 are situated within a communication range of the communication station, i.e. are present in this communication range. The communication station 1 and the data carriers 2 are adapted to communicate in consecutive time slots.

The communication station 1 includes a source 3 for the power supply of all the parts of the communication station, which are to be powered.

The communication station 1 further includes a microcomputer 4. The microcomputer 4 is connected to a so-called host computer, not shown in FIG. 1, via a bus connection 5. The microcomputer 4 includes process control means 6 and interrogation signal generating means 7 and acknowledge signal generating means 8.

In the present case, the process control means 6 include mode switching means 6A, by means of which it is possible to switch between a “transmit” mode and a “receive” mode. In a manner not shown, the mode switching means 6A perform the change-over or control of all those parts of the communication station 1 which should be switched over in order to switch between the “transmit” mode and the “receive” mode. Such mode switching means 6A need not necessarily be provided because accurate information about the times of appearance and about the time sequence of transmitting states and receiving states is available anyway in the communication station.

The process control means 6 further include response signal identification means 6B, with the aid of which each response signal RDB supplied by a data carrier 2 and received by the communication station 1 can be identified and, consequently, each data carrier 2 can be identified. The response signal identification means 6B may also take the form of a unit separate from the process control unit 6 within the microprocessor 4.

According to the invention, the response signal identification means 6B are adapted to identify response signals RDB of the data carriers 2, which response signals RDB may have different lengths L, L1, L2, as will be explained later on, and not only response signals with one fixed length.

The interrogation signal generating means 7 are adapted to generate interrogation signals IDB. However, the interrogation signal generating means 7 are capable of generating not only the interrogation signals IDB but also other command signals, for example write command signals or read command signals or erase signals and other signals.

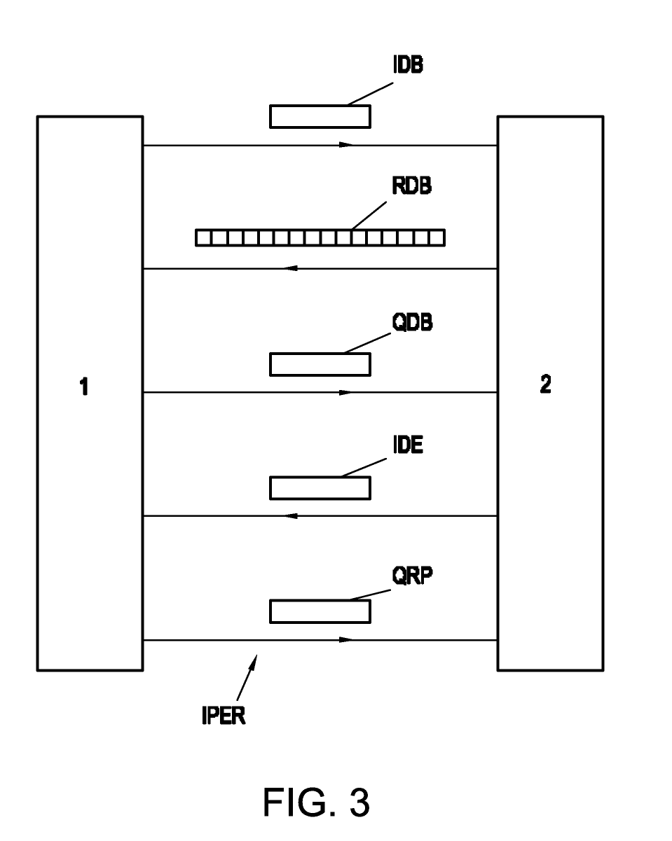

By means of each interrogation signal IDB it is possible to start an interrogation cycle IPER of an interrogation process: such an interrogation cycle IPER is shown in FIG. 3. Each interrogation signal IDB takes the form of a digital signal, which digital signal represents a bit string of a given number of bits.

The acknowledge signal generating means 8 are adapted to generate acknowledge signals QDB. With the aid of the acknowledge signal generating means 8 an acknowledge signal QDB can be generated for each data carrier 2, which, as will be described in more detail hereinafter, is adapted to generate and supply a response signal RDB and from which data carrier 2 such a response signal RDB has been received separately by the communication station 1 and has thus been identified unambiguously with the aid of the communication station 1, which acknowledge signal QDB can be supplied to the relevant identified data carrier 2.

As regards the acknowledge signals QDB, it is to be noted that in the present case each acknowledge signal QDB is formed by a digital signal, which digital signal represents a bit string of a given number of bits.

The communication station 1 further comprises transfer means 27 that form both station transmitting means and station receiving means. The transfer means 27 include a transmission coil 28 shown in FIG. 1. In the “transmit” mode the transfer means 27, which transfer means 27 then operate as station transmitting means, can transfer an interrogation signal IDB or an acknowledge signal QDB to all the data carriers 2 present within the communication range of the communication station 1.

In response to the reception of an interrogation signal RDB some of the data carriers 2 or each data carrier 2 present within the communication range of the communication station 1 generates a response signal RDB. The response signal RDB generated by each data carrier 2 is transferred from the relevant data carrier 2 to the transfer means 27 in the communication station 1. In this case, the communication station 1 is, of course, in the “receive” mode. In the “receive” mode the transfer means 27 operate as station receiving means. In the “receive” mode the transfer means 27 can receive all the response signals RDB supplied by all the data carriers 2 within the communication range of the communication station in response to a received interrogation signal IDB.

Each of the response signals RDB transmitted by the data carriers 2 and received by the communication station RDB is formed by a digital signal, which digital signal represents a bit string having a given number of bits.

The response signal identification means 6B enable response signals RDB that appear singly to be identified unambiguously.

Furthermore, the communication station 1 comprises length defining means 10, with the aid of which length information LIN can be provided, which length information LIN is transmitted to the data carriers 2. Usually, as will be described in more detail later, the length information LIN will be transmitted to the data carriers 2 as part of the interrogation signal IDB.

The data carrier 2 shown in FIG. 2 will now be described hereinafter.

The data carrier 2 has transfer means 40, which form both data carrier receiving means and data carrier transmitting means. The transfer means 40 include a transmission coil 41, which is shown in FIG. 2.

An interrogation signal IDB supplied by the communication station 1 and an acknowledge signal QDB supplied by the communication station 1 can be received with the aid of the transfer means 40. Furthermore, a response signal RDB generated by the data carrier 2 can be supplied to the communication station 1 with the aid of the transfer means 40.

By means of the microcomputer 55 process control means 56 are realized, which means include switching means 56A. The switching means 56A serve to and are adapted to switch the data carrier 2 between its “receive” mode and its “transmit” mode. All the parts of the data carrier 2 which require such a changeover can be switched over with the aid of the switching means 56.

It is to be noted that instead of the microcomputer 55 a hard-wired logic circuit may be provided.

The microcomputer 55 is further used to realize signal detection means 58, with the aid of which interrogation signals IDB can be detected, and memory means 60, which have a user-data memory section 61 and a serial-number memory section 62, and interrogation signal generating means 63.

The interrogation signal IDB transferred from the communication station 1 to the data carrier 2 can be detected and evaluated with the aid of the signal detection means 58.

The detected interrogation signal IDB is available in the signal detection means 58. Upon evaluation of the detected interrogation signal IDB the signal detection means 58 supply detection information to the process control means 56 via an electrically conductive connection 67.

An acknowledge signal QDB transferred from the communication station 1 to the data carrier 2 and received with the aid of the transfer means 40 can be detected with acknowledge signal detection means which in the depicted embodiment are identical to the signal detection means 58 for detecting interrogation signals. The detected acknowledge signal QDB is available in the signal detection means 58. Upon completion of the evaluation the signal detection means 58 supply corresponding detection information to the process control means 56.

The memory means 60 serve to store data and information that is required in the data carrier 2 and which is important for the data carrier 2. The user data memory section 61 mainly serves to store user data, i.e. data of the user of the data carrier 2, for example to store the value of a credit or the magnitude of a price or a type designation and many other data. The serial number memory section 62 serves to store a so-called serial number, which serial number is characteristic of the data carrier 2. A special serial number is assigned to each data carrier 2 and is stored in the serial number memory section 62, as a result of which each data carrier 2 can be distinguished from all the other data carriers 2 with the aid of the serial number. The memory means 60 are connected to the process control means 56 via an electrically conductive connection 69, bi-directional communication (read/write) being possible via the connection 69.

The response signal generating means 63 are connected to the process control means 56 via an electrically conductive connection 70. Furthermore, the response signal generating means 63 are connected to the serial number memory section 62 via an electrically conductive connection 71. The response signal generating means 63 serve to generate a response signal RDB, the serial number stored in the serial number memory section being reflected in the response signal RDB.

It should be noted that it is not absolutely necessary that the data carriers 2 comprise a serial number. In this case the response signal RDB may also be a random number, or a part of the data stored in the user data memory section 61 can be reflected in the response signal RDB.

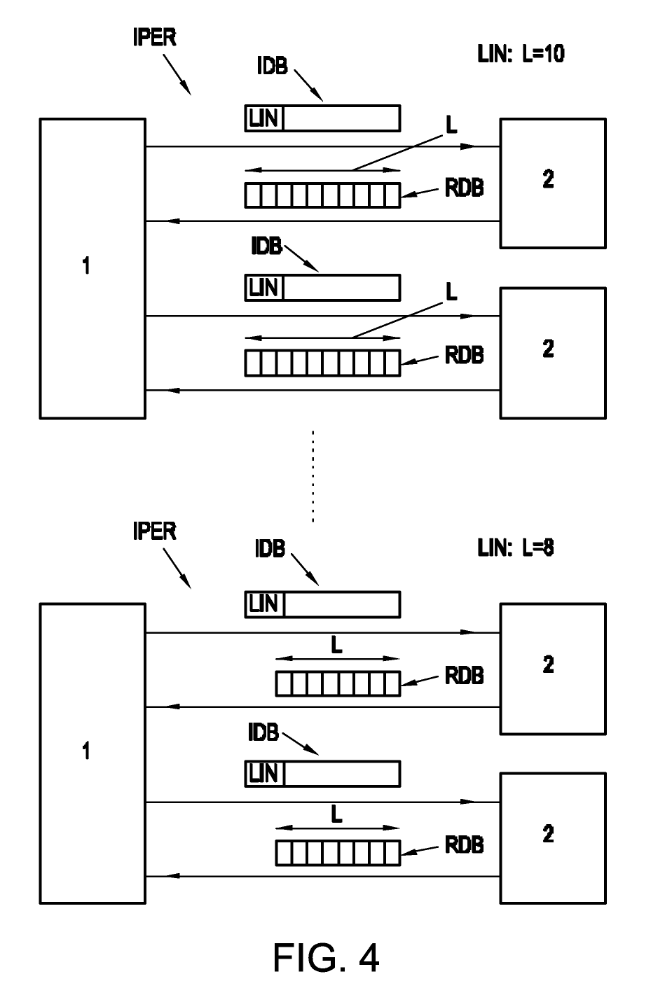

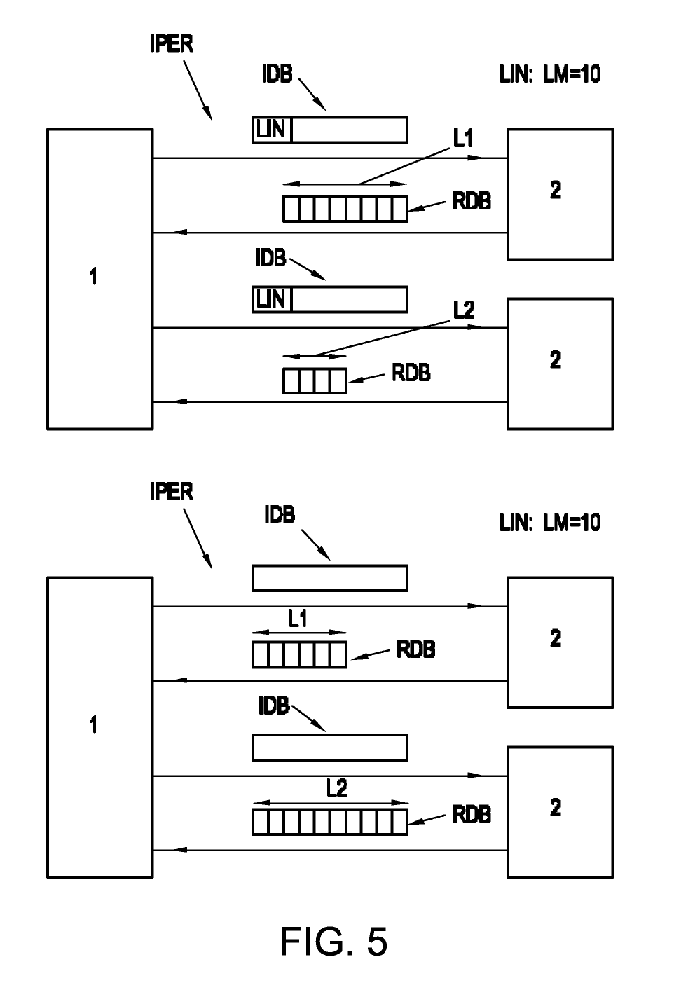

Finally, the data carrier 2 comprises length-determining means 64 for determining the length of the response signals RDB. Such length determining means 64 are only necessary in a specific embodiment of the invention as described with FIG. 5, where the data carriers 2 determine the length of the response signals RDB. In the preferred embodiment as shown in FIG. 5 the length generating means 64 is a random number generator 64. It is to be noted that in another embodiment as depicted in FIG. 4—provided that the response signal RDB is based on the serial number of the data carrier 2 or other information, but not on a random number—length-determining means such as the random number generator 64 is not necessary for the data carrier 2.

A method of communicating between the communication station 1 shown in FIG. 1 and a data carrier 2 as shown in FIG. 2 will now be described hereinafter. Of the complete communication process, in which it is possible, for example, to write data into the user data memory section 61 of each data carrier 2 or to read data from this user data memory section 61, only the relevant part will be described, i.e. the interrogation process required at the beginning of such a communication process, in which interrogation process the data carriers 2 already present in the communication range of the communication station 1 at the start of the interrogation process as well as data carriers 2 which newly enter the communication range of the communication station 1 in the course of such an interrogation process are accurately detected and identified.

An interrogation process according to the state of the art is depicted in FIG. 3. The communication station 1 sends in the “transmit” mode an interrogation signal IDB to the data carriers, of which only one data carrier 2 is shown in FIG. 3. The data carrier 2 answers with a response signal RDB with a fixed length. The term “fixed length” in this context means that all data carriers 2 present in the communication range of the communication station 1 always answer with a response signal RDB with an equal length, and wherein the length of the response signal RDB is not changed in the subsequent interrogation cycles, thus the length of the response signals being fixed to a certain length for all interrogation cycles. According to FIG. 3 the response signal RDB is a digital signal that has a length of 16 bits.

According to the standard EPC™ “Radio-Frequency Identity Protocols Class-1 Generation-2 UHF RFID Protocol for Communications at 860 MHz-960 MHz” a random number with a fixed length of 16 bits is used for the response signal of the data carriers, which random number for example is generated with the aid of the random number generator 64.

According to a specification with respect to the identification of RFID-tags (see the documents WO 2000/004 485 A1=U.S. Pat. No. 6,583,717 B1=EP 1 034 503 B1) also a response signal RDB may be used which is a part of the serial number of the data carrier 2.

In the case that the data carrier 2 is identified unambiguously in the communication station 1 by the response signal RDB then the communication station 1 transmits an acknowledge signal QDB to the identified data carrier 2. As an answer to this acknowledge signal QDB the data carrier 2 responds with an identification signal IDE.

The identification signal IDE is generated with identification signal generating means, which in the depicted embodiment are identical to the response signal generating, means 63. The response signal generating means 63 receive the necessary information for generating an identification signal IDE from the memory means 60.

After receiving the identification signal IDE the communication station 1 finally answers with a query reply signal QRP to the data carrier 2.

According to the invention it is now provided that the data carriers 2 are adapted to answer with a response signal RDB, which response signal RDB may have different length L, L1, L2 in different interrogation cycles IPER. Thus, the length L, L1, L2 of the response signal RDB can be adjusted to achieve a fast identification of data carriers 2 under different circumstances, and at the same time it is possible to minimize the probability of the already mentioned so-called collisions.

For example, if there are a lot of data carriers 2 in the communication range of the communication station 1, then a greater length L, L1, L2 is used for the response signals RDB then in the case of a small number of data carriers 2. In the case that there will be only one data carrier 2 be present in the communication range then the length L, L1, L2 of the response signal RDB may be set to “1”, which means in the case of a digital response signal RDB that the response signal RDB consists of a single bit.

As already mentioned above the response signal RDB is usually formed by a digital signal, which digital signal represents a bit string having a number of bits. In this case the length of the response signal is equal to the number of bits in the response signal, thus for example a response signal with 16 bits having a length of 16.

The response signal generating means 63 of the data carrier 2 are adapted to generate response signals RDB with different length L, L1, L2. Furthermore, the data carrier 2 comprises length information detecting means 58, with the aid of which length information LIN received from the communication station 1 can be detected, said length information LIN describing the length L of the response signal RDB.

In a further embodiment of the invention, the length L1, L2 of the response signals RDB is determined by a random number, the value of the random number being determined by random generator means of the data carriers 2. Separate random generating means may be provided, but usually the random generator 64, which is also used for determining a random number on which the response signal RDB is based may be used for this purpose. In this case the length information LIN provided by the communication station 1 contains a maximum allowed value LM for the random numbers, which determine the lengths L1, L2 of the response signals RDB of the data carriers 2.

In the embodiment of a data carrier 2 as shown in FIG. 2 the length information detecting means 58 are identical to the signal detection means 58.

The length information LIN is provided by the communication station 1 by a length information signal, which length information signal is preferably the interrogation signal IDB. Thus, the length information LIN is part of the interrogation signal IDB. Using the interrogation signal IDB for providing the data carriers 2 with the length information LIN provides the advantage that it is not necessary to change the course of the well-known interrogation cycle IPER.

As already mentioned in the description of FIG. 1 the communication station 1 comprises length defining means 10, with the aid of which the interrogation signal generating means 7 can be provided with the respective length information LIN to be included in the interrogation signal IDB.

After evaluating the interrogation signal IDB in the data carrier 2 with the signal detection means 58 the length information LIN is present in the signal detection means 58, which then supply the length information LIN to the process control means 56.

According to the length information LIN the process control means 56 run the signal generating means 58 to generate a response signal RDB with a length according to said length information LIN.

As mentioned above, the response signal RDB is generated reflecting the serial number of the data carrier 2 as stored in the serial number memory section 62, or the response signal RDB is based on a random number generated with the aid of the random number generator 64.

The communication station 1 can receive instructions of how to define or to determine the length of the response signals from a host computer or the communication station is adapted to determine itself which length information has to be provided to the data carriers. For example, the communication station may comprise means for detecting the number (not shown in the figures) of data carriers 2 in the communication range. It is then possible to immediately adapt the length L, L1, L2 of the response signals RDB of the data carriers 2 accordingly.

Typical values for the length of response signal are 1, 8, 16, or 32.

In an embodiment of the invention as depicted in FIG. 4—for simplicity only two data carriers 2 are shown—the length L of the response signal RDB for the corresponding interrogation cycle IPER is already determined by the communication station 1 as described above. Length information LIN containing the value of the length L of the response signals RDB is transmitted as part of the interrogation signal IDB from the communication station 1 to the two data carriers 2 as shown in FIG. 4. Both data carriers 2 then answer with a response signal RDB with the same length L.

For the shown example according to FIG. 4 it is assumed that the value of the length L as determined by the communication station 1 is L=10 for the first interrogation cycle IPER. The (digital) response signals RDB of both data carriers 2 thus consist of 10 bits in the first interrogation cycle IPER. In the next or one of the following interrogation cycles IPER a new length information LIN is transmitted by the communication station 1. As shown, L=8 is for the length of the response signals RDB in said interrogation cycle IPER, and both data carriers 2 answer with a response signal RDB with a length of L=8 bits.

In this embodiment of the invention the length L of the response signals RDB may vary in different interrogation cycles IPER, but the response signals RDB of all responsive data carriers 2 in a particular interrogation cycle IPER have the same length L.

In a further embodiment as depicted in FIG. 5 the length L1, L2 of the response signals RDB provided by the two data carriers 2 are determined by the data carriers 2 with the means of the random number generator 64 as shown in FIG. 2. Thus, different data carriers 2 may transmit response signals RDB with different lengths L1, L2 in a particular interrogation cycle IPER.

For the example shown in FIG. 5 it is assumed that the length information provided by the communication station 1 for the first interrogation cycle IPER defines a maximum value LM=10 for the maximum length of the response signals RDB provided by the data carriers 2. As depicted, the upper data carrier 2 then provides (for example) a response signal RDB with a length L1 of 8 bits in the first interrogation cycle IPER, whereas the other data carrier 2 provides a response signal RDB with a length of L2=4 bits.

For the next interrogation cycle IPER still LM=10 is assumed to be valid. The upper data carrier 2 now provides a response signal RDB with a length of L1=6 (bits), whereas the second data carriers 2 provides a response signal RDB with a length L2 of 10 bits.

In this embodiment the lengths L1, L2 of the response signals RDB of different data carriers 2 may be different in a particular interrogation cycle IPER, and furthermore the length L1, L2 of a particular data carrier 2 usually also vary in different interrogation cycles IPER.

Usually it is provided that the communication station 1 transmits at the beginning of each interrogation cycle IPER length information LIN to the data carriers 2. However, it may also be provided that a length information LIN transmitted to the data carriers 2 is valid for a number of subsequent interrogation cycles, for example for 100 interrogation cycles. In this case it is not necessary that the communication station transmits the length information LIN in each interrogation cycle. The length information LIN is stored in the data carriers 2 and the data carriers 2 generate response signals RDB according to this length information LIN until the length information LIN stored in the data carriers 2 is overwritten with a new length information from the communication station 1.

It is to be noted that the data carriers 2 are adapted to generate response signals according to an embodiment of the invention as described in FIG. 4 or as described in FIG. 5. However, it may also be provided that the data carriers 2 are adapted to generate response signals RDB according to both embodiments of the invention. The information of how to generate the response signals RDB (specific length L as defined by the communication station 1 or random number length L1, L2 with a maximum value LM) is then provided by the communication station, usually with the interrogation signal and/or included in the length information.

Finally, in a simple embodiment of the invention it is sufficient when the communication station 1 is adapted to receive and identify response signals RDB of different length. The data carriers 2 are well-known data carriers 2 which are only capable of generating response signals RDB with one length. However, if there are some data carriers 2 with a fixed length, for example a length of 8 bits, and other data carriers 2 with a fixed length of, for example, 16 bits in the communication range of the communication station 1, then a similar effect as in the above described cases may be achieved, namely that different data carriers 2 can or will answer with response signals RDB of different length. This embodiment of the invention is less flexible then the above described solutions, but in this solution it is possible to use less sophisticated and thus cheaper data carriers 2.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware or software. The mere fact that certain measures are recited in mutually different dependent claims does not indicate that a combination of these measures cannot be used to advantage.

1. A method of communication between a communication station and data carriers, the data carriers are present within a communication range of the communication station, in which for starting an interrogation cycle the communication station supplies an interrogation signal to the data carriers present within the communication range, and in which during an interrogation cycle at least some of the data carriers present within the communication range which receive the interrogation signal each supply a response signal in response to the interrogation signal, wherein the response signals supplied by the data carriers and received by the communication station have a length, and wherein said length of said response signals is determined in or before an interrogation cycle before the response signals with said length are supplied by the data carriers in response to the interrogation signal.

2. A method as claimed in claim 1, wherein the length of the response signal is determined in or before each said interrogation cycle.

3. A method of claimed in claim 1, wherein the lengths of the response signals of the data carriers are random numbers, which said random numbers are determined in or before a given said interrogation cycle.

4. A method as claimed in claim 3, wherein a maximum value for the random numbers is defined before response signals with the lengths according to the random numbers are supplied by the data carriers.

5. A method as claimed in claim 3, where the random number for the length of said response signal of a particular said data carrier is determined by said data carrier.

6. A method as claimed in claim 1, wherein the length of the response signals or the maximum value for the random numbers is defined by the communication station, and wherein the length information describing said length of the response signals or said maximum value for the random numbers is transmitted by the communication station to the data carriers, and wherein the data carriers generate the response signals according to said length information, which the response signals are then supplied to the communication station.

7. A method as claimed in claim 6, wherein said length information is transmitted from the communication station to the data carriers as part of the interrogation signal.

8. A communication station for the communication with data carriers, the data carriers are present within a communication range of the communication station, in which a communication station interrogation signal generating means have been provided, with the aid of which an interrogation signal can be generated for starting an interrogation cycle, and in which transfer means have been provided, with the aid of which the generated interrogation signal can be supplied to the data carriers present within the communication range, so that the interrogation signal can be received by the data carriers present within the communication range, and in which station receiving means have been provided, with the aid of which response signals supplied by the data carriers in response to a received said interrogation signal can be received, and wherein response signal identification means are provided, with the aid of which said response signals with different lengths can be identified.

9. A communication station according to claim 8, wherein length defining means have been provided, with the aid of which a length of the response signals and/or a maximum value for random numbers, said random numbers determining the length of the response signals, may be defined, and with the transfer means for transferring length information describing said length or said maximum value for said random numbers determining the length of the response signals to the data carriers.

10. A communication station as claimed in claim 9, wherein the length information is transmitted from the communication station to the data carriers as part of the interrogation signal.

11. A data carrier for communication with a communication stationing, said communication station has a communication range, in which said communication range such said data carrier is present, and in which data carrier data carrier receiving means have been provided, with the aid of which an interrogation signal supplied by the communication station can be received, and in which response signal generating means have been provided, with the aid of which a response signal can be generated in response to the received interrogation signal and in which data carrier transfer means have been provided, with the aid of which the generated response signal can be supplied to the communication station, and in which the response signal generating means are adapted to generate response signals of different length.

12. A data carried as claimed in claim 11, wherein random number generating means have been provided, with the aid of which the response signal generating means are capable to generate the response signals with a length corresponding to a random number.

13. A data carrier as claimed in claim 11, wherein length information detecting means have been provided, with the aid of which length information received from the communication station can be detected, said length information describing the length of the response signal or a maximum value for a random number, and wherein the signal generating means are adapted to generate the response signal with a length according to said length information detected with the length information detecting means.
